(19) United States
(12) Patent Application Publication
(10) Pub. No.: US 2007/0202339 A1
(43) Pub. Date: Aug. 30, 2007

(54) Epoxy Resin Composition And Epoxy-Polysiloxane Coating Composition

(75) Inventors: Mutsumi Yoshida, Fukuoka (JP); Kazuaki Nishiyama, Chiba (JP); Nobuyuki Furukawa, Nagasaki (JP); Yasuyuki Takeda, Chiba (JP); Makoto Matsuura, Chiba (JP)

Correspondence Address: BIRCH STEWART KOLASCH & BIRCH, PO BOX 747, FALLS CHURCH, VA, 22040-0747, US

(73) Assignee: NIPPON STEEL CHEMICAL CO., LTD., Tokyo (JP)

(21) Appl. No.: 11/632,168

(22) PCT Filed: Aug. 3, 2005
(86) PCT No.: PCT/JP05/14209

§ 371 Date: Jan. 11, 2007

(30) Foreign Application Priority Data
Aug. 9, 2004 (JP) 2004-232018

(51) Int. Cl. B32B 27/38; B32B 9/04

(52) U.S. Cl. 428/413; 525/476; 528/23; 428/447

(57) ABSTRACT

This invention relates to an epoxy resin composition suitable for a solvent-free, one-component, room temperature-curable coating composition and to an epoxy-polysiloxane coating composition showing good adhesion to steel plates and the like and excellent weatherability. This epoxy resin composition comprises (a) an epoxy resin with an epoxy equivalent of 100-1000 g/eq., (b) a silane compound represented by the following general formula (1)
Si(R¹R²R³R⁴) (1)
(wherein R¹ is an alkyl group of 1-6 carbon atoms and R²-R⁴ are hydrogen atoms, alkyl groups of 1-10 carbon atoms, aryl groups, hydroxyl groups, or alkoxy groups of 1-6 carbon atoms) and a condensate thereof, and (c) a phosphoric acid represented by the following general formula (2)
H₍ₙ₊₂₎PₙO₍₃ₙ₊₁₎ (2) as essential components.

### FIELD OF TECHNOLOGY

This invention relates to an epoxy resin composition and, more particularly, to an epoxy resin composition which shows excellent adhesive properties, flexibility, and weatherability and is suitable for a solvent-free, one-component, room temperature-curable coating composition.

### BACKGROUND TECHNOLOGY

Silicone resins are used widely in a variety of fields for their capability of forming films which are highly resistant to weather, heat, and chemicals. Silicone resins whose molecular ends are blocked by alkoxysilyl groups, that is, silicone resins containing terminal Si—OR groups, are called alkoxy oligomers and cure by the action of moisture in the air at room temperature. For this reason, they are utilized as solvent-free coatings applicable on the spot. Although alkoxy oligomers advantageously possess enhanced surface hardness due to the three-dimensional crosslinked structure, they face a problem of insufficient flexibility causing occasional generation of cracks on the coating and another problem of poor adhesion to a substrate such as steel.

Epoxy resin compositions comprising bisphenol type liquid epoxy resins and curing agents such as polyamines and polyamidepolyamines are used widely for their excellent adhesive properties and corrosion resistance, but they have a problem of poor weatherability.

To remedy the aforementioned defects, combinations of epoxy resins and alkoxy oligomers have been proposed to provide compositions which cure at room temperature with excellent corrosion resistance and weatherability.

Patent reference 1: JP10-509195 A

Patent reference 2: JP2000-345104 A

Patent reference 3: JP2002-265869 A

Patent reference 4: JP8-176304 A

Patent reference 5: JP2001-114897 A

For example, patent reference 1 discloses a mixture of an epoxy resin, a polysiloxane, an organosiloxane, an aminosilane, and an organic tin catalyst. Patent reference 2 discloses a coating composition comprising a resin composition containing the reaction product of an epoxy resin, a compound having a carboxyl group, and an organosiloxane having a specified alkoxysilyl group and an amino group-containing compound. However, these coating compositions have problems in that they are highly viscous and must be diluted with a solvent and they are of the two-component type requiring mixing on the application spot.

Patent reference 3 discloses a coating composition obtained by polycondensing a composition comprising an epoxy group-containing silicon compound, an alkoxysilane, and particulate silicon in the presence of a phosphoric acid-based catalyst. Patent reference 4 discloses a method for producing alkoxysilane condensation products useful for modifying acrylic urethane coatings. Patent reference 5 discloses epoxy-modified alkoxysilane condensation products whose heat resistance is improved by incorporation of epoxy resins in or reaction of epoxy resins with alkoxysilane condensation products.

### DISCLOSURE OF THE INVENTION

### Problems to be Solved by the Invention

An object of this invention is to provide an epoxy resin composition which is an improvement over somewhat defective room temperature-curable compositions and is suitable for a solvent-free, one-component, room temperature-curable composition developing strong adhesion to a steel plate and showing excellent weatherability. Another object of this invention is to provide an epoxy-polysiloxane coating composition usable as a solvent-free, one-component, room temperature-curable composition.

### MEANS TO SOLVE THE PROBLEMS

The inventors of this invention have conducted studies from all angles to solve the aforementioned problems, found that the incorporation of condensed phosphoric acid or phosphoric anhydride in an epoxy resin and a low-molecular-weight organopolysiloxane containing a specified alkoxysilyl group gives a one-component, room temperature-curable resin composition which shows good storage stability and excellent adhesive properties, corrosion resistance, and weatherability, and completed this invention.

Accordingly, this invention relates to an epoxy resin composition comprising

(a) an epoxy resin with an epoxy equivalent of 100-1000 g/eq. (hereinafter also referred to as component a),

(b) a silane compound represented by the following general formula (1)
Si(R¹R²R³R⁴) (1)
(wherein R¹ is an alkyl group of 1-6 carbon atoms, R², R³, and R⁴ are hydrogen atoms, alkyl groups of 1-10 carbon atoms, aryl groups, hydroxy groups, or alkoxy groups of 1-6 carbon atoms) and a condensate thereof (hereinafter also referred to as component b), and
(c) condensed phosphoric acid represented by the following general formula (2)
H₍ₙ₊₂₎PₙO₍₃ₙ₊₁₎ (2)
(wherein n is an integer of 2 or more) or phosphoric anhydride (either is hereinafter also referred to as component c) as essential components.

Preferably, the components a, b, and c respectively account for 1-90 parts by weight, 10-90 parts by weight, and 0.1-10 parts by weight of the aforementioned epoxy resin composition. In the case where the composition contains another non-solvent component (hereinafter also referred to as component d) such as a pigment, the component d is preferably in the range of 10-60 wt %. Of epoxy resins, aliphatic epoxy resins can be used advantageously. The epoxy resin composition here contains both of a silane compound (hereinafter also referred to as component b1) and a condensate thereof (hereinafter also referred to as component b2) and the ratio (by weight) of component b1 to component b2 is advantageously in the range of 10/90 to 50/50.

This epoxy resin composition is suitable for an epoxy-polysiloxane coating. This composition can be prepared by mixing condensed phosphoric acid or phosphoric anhydride with a silane compound and then incorporating the resulting mixture in a mixture of the condensate of the silane compound and an epoxy resin. This invention further relates to an epoxy-polysiloxane film formed by applying the aforementioned epoxy resin followed by curing.

This invention is described further below. Although an epoxy resin with an epoxy equivalent of 100-1000 g/eq. is generally used as the component a, an epoxy resin with an epoxy equivalent of 100-500 g/eq. is preferred in consideration of the compatibility of the component a with the component b and the viscosity of the composition. A candidate for this kind of epoxy resin advantageously has two or more epoxy groups in the molecule and, preferably, it is a bifunctional epoxy resin containing two epoxy groups or an epoxy resin mixture containing 60 wt % or more of a bifunctional epoxy resin. It is allowable to use a monofunctional glycidyl compound in order to adjust the degree of crosslinking. Regarding the kind of epoxy resin to be used, aliphatic epoxy resins are preferable from the viewpoint of weatherability and they include alicyclic epoxy resins. An epoxy resin containing two or more epoxy groups in the molecule preferably has a structure formed by linking epoxy groups to an aliphatic or aromatic hydrocarbon group and is free from other substituents. Preferred aliphatic epoxy resins are those derived from a dihydric or higher aliphatic alcohol (including an alicyclic aliphatic alcohol) and an epihalohydrin. It is preferable to use a bifunctional or higher aliphatic epoxy resin in an amount corresponding to 60 wt % or more of the entire epoxy resins.

Concrete examples of the epoxy resins useful for the component a are aromatic epoxy resins such as bisphenol A diglycidyl ether, bisphenol F diglycidyl ether, and xylylene glycol diglycidyl ether, cyclohexanedimethanol diglycidlyl ether, hydrogenated bisphenol A diglycidyl ether, hydrogenation products of bisphenol A type epoxy resins, and aliphatic epoxy resins such as polypropylene glycol diglycidyl ether, trimethylolpropane triglycidyl ether, 1,6-hexanediol diglycidyl ether, and neopentyl glycol diglycidyl ether. Any one or a mixture of two or more may be chosen suitably from the aforementioned epoxy resins. Monofunctional glycidyl compounds to be used together include monofunctional epoxy compounds such as butyl glycidyl ether and 2-ethylhexyl glycidyl ether and epoxysilane compounds such as γ-glycidoxypropoxytrimethoxysilane, γ-glycidoxypropoxytriethoxysilane, and γ-glycidoxypropoxymethyldiethoxysilane.

The silane compound designated as the component b and a condensate thereof are a silane compound represented by the aforementioned general formula (1) and a condensate thereof. General formula (1) can be written as follows.

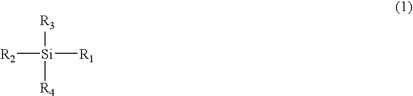

In formula (1), R¹ is an alkoxy group represented by OR, R², R³, and R⁴ are independently hydrogen atoms, halogens, alkyl groups of 1-10 carbon atoms, preferably of 1-6 carbon atoms, more preferably of 1-4 carbon atoms, aryl groups, OH groups or OR groups. At least one of R¹-R⁴ is OR and, preferably, two or more are OH or OR. Advantageously, at least one of R²-R⁴ is OR and at least one is an alkyl or aryl group. The group R in the aforementioned OR group is an alkyl group of 1-6 carbon atoms, preferably of 1-4 carbon atoms.

A silane compound to be used satisfactorily as the component b1 must at least undergo condensation to give an organopolysiloxane and this necessitates that the principal component of the compound in question is a polyfunctional silane compound having two or more condensation-reactive functional groups other than hydrocarbon groups, for example, OH and OR groups. However, the presence of a monofunctional silane in a small amount is not a serious obstacle to the formation of an organopolysiloxane and all the silane compounds need not be polyfunctional. From the viewpoint of not only performance but also commercial availability, it is preferable to use a silane compound represented by the aforementioned general formula (1) wherein R¹ and R² are methoxy or ethoxy, R³ is methyl or phenyl, and R⁴ is methoxy, ethoxy, methyl, or phenyl.

Concrete examples of the component b1 are tetrafunctional alkoxysilanes such as tetramethoxysilane, tetraethoxysilane, and methyl cellosolve orthosilicate, trifunctional alkoxysilanes such as methyltrimethoxysilane, methyltriethoxysilane, ethyltrimethoxysilane, vinyltrimethoxysilane, phenyltrimethoxysilane, phenyltriethoxysilane, and methytrimethoxyethoxylsilane, and bifunctional alkoxysilanes such as dimethyldimethoxysilane, dimethyldiethoxysilane, diphenyldimethoxysilane, and diphenyldiethoxysilane.

The condensate of the silane compound designated as the component b2 is a low-molecular-weight organopolysiloxane oligomer containing reactive functional groups and it is preferably a low-molecular-weight liquid silicone resin or organic siloxane compound simultaneously containing an organic substituent such as an alkyl group and a hydrolysis-reactive functional group such as an alkoxy group in the molecule. From the viewpoint of compatibility with an epoxy resin, the condensate preferably is a liquid with a degree of condensation of 2-15. The condensate of the component b2 may be one kind or a combination of two kinds or more and it may contain a small amount of a silane compound.

The condensate of the silane compound designated as the component b2 is preferably a condensate obtained by partial hydrolysis of the aforementioned silane compound designated as the component b1. However, it is not necessary that the silane compound designated as component b1 matches the silane compound in the condensate designated as component b2 and a condensate of a silane compound other than the component b1 may be used as long as this silane compound is within the range satisfying the aforementioned general formula (1). This component b2, like the component b1, undergoes condensation to give an organopolysiloxane with higher molecular weight. Preferred component b1 yields preferred component b2.

Concrete examples of the aforementioned condensate are DC3074, DC3037, and SR2402 (products of Dow Corning Toray Silicone Co., Ltd.), KR-9218, KR-500, KR-400, X40-9225, KR-510, X40-9227, and X40-9247 (products of Shin-Etsu Chemical Co., Ltd.).

Condensed phosphoric acid or phosphoric anhydride designated as the component c is typically a condensed phosphoric acid represented by the aforementioned general formula (2) or phosphoric anhydride represented by P₂O₅. The condensed phosphoric acids represented by general formula (2) refer to products formed by condensation of phosphoric acid (H₃PO₄) with removal of water and include pyrophosphoric acid (n=2), triphosphoric acid (n=3), tetraphosphoric acid (n=4), and acids of higher degree of condensation such as polyphosphoric acids. Phosphoric anhydride may be regarded as a product formed by further removal of water. These condensed phosphoric acids and phosphorus pentoxide may be used singly or as a mixture of two kinds or more.

The aforementioned component c may contain a small amount of cyclic condensation products which cannot be represented by general formula (2), for example, condensed metaphosphoric acids. Now, an aqueous solution of phosphoric acid which is generally used in a wide variety of commercial applications is not desirable here because the solvent water shortens the pot life of coatings or adversely affects the storage stability of coatings. However, this adverse effect can be minimized and phosphoric acid (n=1) can be used if its concentration is kept at 60 wt % or more. In consequence, the condensed phosphoric acids represented by general formula (2), inclusive of phosphoric acid (n=1), and phosphoric anhydride (hereinafter collectively referred to as phosphoric acids) are used as the component c. This component c has been found to act singularly in the formation of an epoxy-polysiloxane composition.

When a composition of this invention is applied as a coating, an adhesive, and the like, the component c absorbs moisture and partly changes into phosphoric acid thereby manifesting the activity as a curing catalyst against the components a and b, that is, the component c acts as a kind of latent curing catalyst. The unchanged component c acts as a crosslinking agent to form —Si—O—P—O—Si—, —C—O—P—O—C—, and —Si—O—P—O—C— bonds in the curing system of a polysiloxane (a silicone resin) and an epoxy resin where a different curing mechanism works and accelerates curing to form a tough film. The formation of a composite of Si and P in a crosslinked structure is effective for enhancing the flame retardance of a coating film.

Phosphoric acid which previously acted as a catalyst now reacts with an alcohol which is a byproduct in the curing reaction leading to the formation of a silicone resin and the resulting phosphate ester acts as a plasticizer after completion of the curing to give a film of excellent processability.

An epoxy resin composition provided by this invention can be used as a solvent-free clear coating and, besides the essential components a, b, and c, it may contain pigments such as coloring pigments and extender pigments, dehydrating agents, and fillers in suitable amounts as other components (component d).

The coloring pigments include inorganic pigments such as titanium oxide, zinc oxide, carbon black, ferric oxide (red oxide), chrome yellow, yellow iron oxide, ocher, ultramarine blue, and cobalt green and organic pigments such as azo pigments, naphthol pigments, pyrazolone pigments, anthraquinone pigments, perylene pigments, quinacridone pigments, diazo pigments, isoindolinone pigments, benzimidazole pigments, phthalocyanine pigments, and quinophthalone pigments. The extender pigments include calcium carbonate, clay, kaolin, talc, precipitated barium sulfate, barium carbonate, white carbon, and diatomaceous earth.

The dehydrating agents include synthetic silica, activated alumina, zeolite, slaked lime, metal alkoxides, and organic alkoxy compounds.

The coloring pigments, extender pigments, and the like are preferably incorporated at a rate of 10-60 wt %. The method for dispersing pigments is not limited and the pigments are mixed with the component a and dispersed in a ball mill or a sand mill.

According to this invention, each component is incorporated as follows to provide an epoxy resin composition.

First, it is preferable to incorporate 1-90 parts by weight of the component a, 10-90 parts by weight of the component b, and 0.1-10 parts by weight of the component c to make the total of the three components 100 parts by weight.

The incorporation of 1 part by weight or less of the component a lowers the corrosion resistance and adhesive properties while the incorporation of 50 parts by weight or more tends to lower curability at room temperature. Therefore, the incorporation of the component a is preferably 5-50 parts by weight, more preferably 10-30 parts by weight.

The component b is divided into the component b1 or a silane compound and component b2 or the condensate of the silane compound. The component b1, similarly to the component b2, yields a polysiloxane and it plays a role of orienting silyl groups on the surface of a coating film to improve the weatherability and another role of acting as a crosslinking agent in forming the crosslinked structure of a siloxane. The component b is a good solvent of the component c and enhances the storage stability of the composition. The component b is preferably incorporated at a rate of 10-90 parts by weight. The incorporation of 10 parts by weight or less lowers the stability of the coating composition while the incorporation of 90 parts by weight or more lowers the flexibility of a film and the corrosion resistance.

The ratio of the b1 component to the b2 component in the component b is chosen as follows to maintain compatibility and curability in good balance; 5-70 wt % of b1 vs. 95-wt % of b2, preferably 10-50 wt % of b1 vs. 90-50 wt % of b2, more preferably 10-30 wt % of b1 vs. 90-70 wt % of b2. The weatherability lowers when the b2 component is 30 wt % or less while the corrosion resistance lowers when the b2 component is 95 wt % or more.

The component c which acts as a curing catalyst can be incorporated at a controlled rate to adjust the curability and is incorporated preferably at a rate of 0.1-10 parts by weight, more preferably at a rate of 3-7 parts by weight, because the incorporation of 0.1 part by weight or less slows down the curing and the incorporation of 10 parts by weight or more adversely affects the stability of the coating.

The component c occurs either as a viscous liquid or as a solid and it shows the possibility of undergoing a secondary reaction by absorbing moisture from the air. As the component c shows the highest solubility in the component b1 among all the components to be incorporated, it is preferable to dissolve the component c in the component b1 (or a component containing a large amount of the component b1) in advance and add the resulting solution lastly in the steps for producing the composition. In the case where the component b1 to be used for dissolving the component c contains the component b2, the content of the component b2 is preferably kept at 20 wt % or less from the viewpoint of solubility and stability. It is sufficient to dissolve the component c in the component b1 until or before the solubility of the component c is reached and the remaining component b1 is added lastly in the steps for producing the composition. The method for producing the composition of this invention comprises dissolving the component c in the component b1 and incorporating the resulting solution in a mixture of the component a and the component b2. Where some of the component b1 remains, the component a, the component b2, and the remaining component b1 are mixed in advance. In case the addition of the component d is required, this addition may be made simultaneously with, before, or after the mixing of the foregoing components. The component a and the component b2 may be added together or in succession to the aforementioned solution containing the component c. Moreover, the mixture of the component c and the component b1 may be prepared separately and stored as it is for later use as a material for formulating a composition according to this invention.

The solids contents (the components remaining after curing and containing monomers excepting volatiles such as a solvent) in an epoxy resin composition are preferably as follows: 1-90 wt %, more preferably 540 wt %, for the component a; 10-90 wt %, more preferably 50-85 wt %, for the component b; and 0.1-10 wt %, more preferably 1-5 wt %, for the component c. Where the component d is added, its solids content is 1-60 wt %, preferably 1-20 wt %. In the presence of the component d, the contents of the components a, b, and c are respectively obtained by multiplying the foregoing ranges of respective components by (100−d)/100 wherein d is the numerical value of the component D expressed in wt %. The aforementioned ranges hold good as they are when the component d is incorporated in a small amount (for example, 10 wt % or less). A solvent may be added if necessary, but the addition will cause a loss of one of the effects of this invention, namely, the property of being solvent-free.

An epoxy resin composition provided by this invention can be used for a variety of coatings such as undercoatings and face coatings, adhesives, and fillers. It is particularly useful as a one-component, solvent-free coating. However, it is not limited to these applications.

When the composition is used as a coating, the method for its application is not limited and any of coating techniques such as brushing, spray coating, roller coating, and curtain coating can be used. The thickness of a coating film is not limited and it is usually 10-200 μm, preferably 30-100 μm, after application of one coat.

An epoxy resin composition provided by this invention can be cured at room temperature and it can also be cured by force-drying or heating. When applied to metallic materials such as steel plates, cement-based structures, and inorganic hardened materials, it is capable of forming a film with good adhesive properties, corrosion resistance, and weatherability.

Although the composition requires water for its curing, it cures spontaneously by absorbing moisture from the air. When the composition is applied in thin film, it cures rapidly to form a film which increases adhesive strength, enhances surface hardness, and gives gloss and a beautiful appearance.

### PREFERRED EMBODIMENTS OF THE INVENTION

This invention is described in detail below, but it is not limited to the examples shown there. In the following description, “part” and “%” are on a weight basis unless otherwise specified.

### Example 1

10 parts of ST-3000 (hydrogenated bisphenol A type epoxy resin with an epoxy equivalent of 230 g/eq., a product of Tohto Kasei Co., Ltd.) was mixed with 63 parts of KR-510 (methoxy group-containing methyl/phenyl silicone resin, a product of Shin-Etsu Chemical Co., Ltd.). To this mixture was added a mixture of 4.1 parts of pyrophosphoric acid (a product of Kanto Chemical Co., Inc.) and 23 parts of KBM22 (methyldimethoxysilane, a product of Shin-Etsu Chemical Co., Ltd.) to give a coating composition.

### Examples 2 and 3

Coating compositions were prepared as in Example 1 from ST-3000, KR-510, pyrophosphoric acid, and KBM22 according to the formulations shown in Table 1.

### Examples 4 and 5

Coating compositions were prepared as in Example 1 according to the formulations shown in Table 1 while using YH-300 (aliphatic polyglycidyl ether with an epoxy equivalent of 140 g/eq., a product of Tohto Kasei Co., Ltd.) or YD-128 (bisphenol A type epoxy resin with an epoxy equivalent of 186 g/eq., a product of Tohto Kasei Co., Ltd.) as an epoxy resin.

### Example 6

A coating composition was prepared as in Example 1 from 85% phosphoric acid, ST-3000, KR-510, and KBM22 according to the formulation shown in Table 1.

### Comparative Example 1

A coating composition was prepared as in Example 1 according to the formulation shown in Table 1 without using an epoxy resin.

### Comparative Example 2

A coating composition was formulated from 25.1 parts of ST-3000, 70.4 parts of KR-510, and 4.5 parts of pyrophosphoric acid.

The amounts of respective components used in formulating the coating compositions of the examples and comparative examples are shown in Table 1. The numerical values in the formulations denote parts.

A steel plate which had been degreased by methyl ethyl ketone was coated with each of the coating compositions prepared in the examples and comparative examples to a dry film thickness of approximately 60 μm, dried at room temperature for one week, and tested for flex resistance, corrosion resistance, and weatherability. Moreover, a glass plate was coated with each coating composition to a dry film thickness of approximately 60 μm, dried at a temperature of 23±2° C. and a humidity of 50±5% for one day, and evaluated for compatibility and condition of curing. The test piece for the evaluation of corrosion resistance, weatherability, flex resistance, and adhesive properties was prepared by applying each resin composition to an iron plate to a dry film thickness of approximately 60 μm and drying at a temperature of 23±2° C. and a humidity of 50±5% for three weeks.

TABLE 1

| | | | | | | | Comparative | |
|---|---|---|---|---|---|---|---|---|
| | Example | | | | | | example | |
| | 1 | 2 | 3 | 4 | 5 | 6 | 1 | 2 |
| ST-3000 | 10 | 20 | 30 | | | 10 | | 25.1 |
| YH-300 | | | | 20 | | | | |
| YD-128 | | | | | 10 | | | |
| KBM-22 | 23 | 20.4 | 17.8 | 20.4 | 23 | 22.4 | 25.5 | |
| KR-510 | 63 | 56 | 49 | 56 | 63 | 63 | 70 | 70.4 |
| Pyro- | 4.1 | 3.6 | 3.2 | 3.0 | 4.1 | | 4.5 | 4.5 |
| phosphoric | | | | | | | | |
| acid | | | | | | | | |
| 85% | | | | | | 4.6 | | |
| phosphoric | | | | | | | | |
| acid | | | | | | | | |
| Compati- | ◯ | ◯ | ◯ | ◯ | Δ | ◯ | Δ | X |
| bility | | | | | | | | |
| Condition of | ◯ | ◯ | ◯ | ◯ | ◯ | ◯ | Δ | X |
| curing | | | | | | | | |
| Corrosion | ◯ | ◯ | ◯ | ◯ | ◯ | ◯ | X | X |
| resistance | | | | | | | | |
| Weather- | ◯ | ◯ | ◯ | ◯ | X | ◯ | Δ | X |
| ability | | | | | | | | |
| Adhesive | 25/25 | 25/25 | 25/25 | 25/25 | 25/25 | 25/25 | 5/25 | 0/25 |
| properties | | | | | | | | |
| Flex | ◯ | ◯ | ◯ | ◯ | ◯ | ◯ | X | X |
| resistance | | | | | | | | |
| Stability | ◯ | ◯ | ◯ | ◯ | ◯ | Δ | ◯ | X |

Testing Methods

(1) Compatibility

The condition of the solution after mixing of the components was visually observed and evaluated as follows: ∘, the solution is transparent and forms a transparent film after one day; Δ, turbidity is observed in the film after one day; x, the solution itself forms turbidity, insoluble matters, or precipitates.

(2) Condition of Curing

The film formed on a glass plate was observed visually for transparency and condition of curing and evaluated as follows: ∘, tack-free and sound; Δ, tack remains; x, poor curing.

(3) Corrosion Resistance

The film was submitted to the salt spray test according to JIS K 5600-7-1, observed, and evaluated as follows: ∘, no abnormalities; x, rusting, cracking, or peeling.

(4) Weatherability (Weather Resistance)

The accelerated weathering test of the film was conducted in a sunshine weatherometer for 600 hours and the gloss of the film after the test was compared with that before the test; ∘, no change or a reduction of less than 5%; Δ, a reduction ranging from 5% to less than 10%; x, a reduction of 10% or more.

(5) Flex Resistance (Flexibility)

The test was carried out according to JIS K 5600 5-1.1 using a shaft with a diameter of 10 mm and the flexed film was visually observed: ∘, no cracking nor peeling; x, other than the foregoing.

(6) Adhesive Properties

The film crosshatched by parallel lines at a 2 mm spacing to a pattern of 5×5 squares was submitted to the test according to JIS K 5600 5-1.1 and the number of squares peeled off the substrate was counted. The results were expressed, for example, as 25/25 where all the squares remained or as 0/25 where all the squares peeled off.

(7) Stability

The resin compositions prepared in the examples and comparative examples were stored at 40° C. for one month and their conditions were observed: ∘, no abnormality (rise in viscosity of less than 10%); Δ, some rise in viscosity (from 10% to less than 40%); x, large rise in viscosity (40% or more) or gelling.

### INDUSTRIAL APPLICABILITY

A resin composition provided by this invention can be made into a solvent-free, one-component, room temperature-curable coating composition which is capable of forming a film of excellent corrosion resistance, weatherability, and flex resistance. The coating composition is of high practical value as it is applicable to concrete or iron and steel structures in the civil engineering and construction industry and to specialized coating areas involving a variety of metals, plastic parts of electrical household appliances, and articles for daily life and leisure.

1. An epoxy resin composition comprising
(a) an epoxy resin with an epoxy equivalent of 100-1000 g/eq.,
(b) a silane compound represented by the following general formula (1)
Si(R¹R²R³R⁴) (1)
wherein R¹ is an alkoxy group of 1-6 carbon atoms and R², R³, and R⁴ are hydrogen atoms, alkyl groups of 1-10 carbon atoms, aryl groups, hydroxyl groups, or alkoxy groups of 1-6 carbon atoms; and a condensate thereof, and
(c) condensed phosphoric acid represented by the following general formula (2)
H₍ₙ₊₂₎PₙO₍₃ₙ₊₁₎ (2)
wherein n is an integer of 2 or more; or phosphoric anhydride as essential components.

2. An epoxy resin composition as described in claim 1 wherein the composition contains (a) 1-90 parts by weight of the epoxy resin, (b) 10-90 parts by weight of the silane compound or condensate thereof, and (c) 0.1-10 parts by weight of the condensed phosphoric acid or phosphoric anhydride.

3. An epoxy resin composition as described in claim 1 or 2 wherein the composition contains 10-60% by weight of pigments or fillers.

4. An epoxy resin composition as described in claim 1 wherein the epoxy resin contains two or more epoxy groups in the molecule.

5. An epoxy resin composition as described in claim 4 wherein the epoxy resin is an aliphatic epoxy resin.

6. An epoxy resin composition as described in claim 1 wherein the ratio by weight of the silane compound to the condensate thereof is 10/90 to 50/50.

7. An epoxy resin composition as described in claim 1 wherein the epoxy resin composition is used for an epoxy-polysiloxane coating.

8. A process for producing the epoxy resin composition described in claim 1 which comprises mixing the condensed phosphoric acid or phosphoric anhydride with the silane compound and incorporating the mixture in a mixture of the condensate of the silane compound and the epoxy resin.

9. An epoxy-polysiloxane film formed by applying and curing the epoxy resin composition described in claim 1.

10. An epoxy resin composition comprising
(a) an epoxy resin with an epoxy equivalent of 100-1000 g/eq.,
(b) a silane compound represented by the following general formula (1)
Si(R¹R²R³R⁴) (1)
wherein R¹ is an alkoxy group of 1-6 carbon atoms and R², R³, and R⁴ are hydrogen atoms, alkyl groups of 1-10 carbon atoms, aryl groups, hydroxyl groups, or alkoxy groups of 1-6 carbon atoms; and a condensate thereof, and
(c) a phosphoric acid represented by the following general formula (2)
H₍ₙ₊₂₎PₙO₍₃ₙ₊₁₎ (2)
wherein n is an integer of 1 or more; as essential components.

11. A mixture of a phosphoric acid and a silane compound to be used for producing the epoxy resin composition described in claim 10.
